(19) United States
(12) Patent Application Publication
(10) Pub. No.: US 2024/0083781 A1
(43) Pub. Date: Mar. 14, 2024

(54) TUBULAR REVERSE POLARITY SELF-CLEANING CELL

(71) Applicant: De Nora Water Technologies, LLC, Sugar Land, TX (US)

(72) Inventors: Jose Lopez, Sugar Land, TX (US); Charles Clements, Sugar Land, TX (US); Dana Casbeer, Sugar Land, TX (US); Rudolf Matousek, Sugar Land, TX (US)

(21) Appl. No.: 18/262,906

(22) PCT Filed: Jan. 21, 2022
(86) PCT No.: PCT/US2022/013308

§ 371 Date: Jul. 25, 2023

Related U.S. Application Data
(60) Provisional application No. 63/142,799, filed on Jan. 28, 2021.

(51) Int. Cl. C02F 1/46; C25B 1/26; C25B 9/15

(52) U.S. Cl. CPC C02F 1/4602; C25B 1/26; C25B 9/15; C02F 2001/46119

(57) ABSTRACT

A process for self-cleaning an electrolytic cell involves introducing a stream of seawater into the electrolytic cell having at least one cathode and one anode. The cathode and anode are substantially fully coated with a coating composition. A forward bias is applied between the anode and the cathode at a first current density as seawater flows between the electrodes. Subsequently, a reverse bias is provided at the cathode. The reverse bias is provided at a second current density that is lower than the first current density. When the reverse bias is applied, the polarity of the cathode is reversed for a short duration. This facilitates the generation of a small amount of hydrochloric acid at the previous cathode surface causing the dissolution of calcium, magnesium or other deposits on the surface of the electrodes without damaging the coating composition on the electrodes.

### TECHNICAL FIELD

The present invention relates to electrolytic cells and, in particular, to electrolytic cells used for biocidal treatment of seawater in offshore, nearshore and coastal installations.

### BACKGROUND

The electrolysis of seawater or other dilute aqueous solutions of sodium chloride with consequent generation of active chlorine, that is, of a mixture of hypochlorite and other oxidizing species, finds several applications in the industry which take advantage of the biocidal and disinfecting properties of the product. An application of particular interest is the biocide treatment of seawater in cooling, firewater, utility water, desalinization and other onshore and offshore applications. These are applications where circulating seawater must be treated with a biocide to prevent fouling and blockage of pipes, vessels and channels by the growth of marine organisms. The preventive biocide treatment can involve the in-situ generation of hypochlorite by using electrolytic cells. Seawater electrochlorination eliminates the storage, handling and purchase of hazardous chemicals.

During the electrolysis process, seawater is passed through the electrolytic cells and exits the cell as sodium hypochlorite solution and byproduct hydrogen gas. The solution is piped to a tank or cyclone where hydrogen can be removed from the solution. The resulting solution exiting the cell is a mixture of seawater, hypochlorite, and hypochlorous acid. Electrolysis of sodium chloride solution (seawater) is the passage of direct current between an anode (positive pole) and a cathode (negative pole) to separate salt and water into their basic elements. Chlorine generated at the anode immediately goes through chemical reactions to form hypochlorite and hypochlorous acid. Hydrogen and hydroxide are formed at the cathode, the hydrogen forms a gas and the hydroxide aids in the formation of hypochlorite and increases the exit stream pH to approximately 8.5.

This overall chemical reaction can be expressed as follows:

Salt+Water+Energy→Sodium Hypochlorite+Hydrogen

NaCl+H2O+2e→NaClO+H2

The electrochlorination process can cause fouling of the electrolytic cells due to scale build-up. Scale is a result of hardened calcium and magnesium deposits. Without an active method to remove these deposits, periodic, chemical-based cleaning is required. This may also include the physical removal of cells for cleaning and requires neutralization of spent acid solution.

A common technique for cleaning the electrolytic cells involves periodic washing of the electrodes with hydrochloric acid. This is a simple procedure for a trained technician or an operator, but the overall process is quite arduous and costly not just for equipment downtime, but also for the operational and environmental considerations associated with the procurement, storing and safe disposal of chemicals on any offshore installation.

Some companies offer “self-cleaning” cell technology. The process is based on a high velocity seawater flow principle which can create a “scouring” effect across electrode surfaces and can result in the physical removal of calcium and magnesium scale build-up. However, periodic scouring action has been proven to merely flush away small amounts of deposits. Unfortunately, this method does not eliminate hardness build-up over time and ultimately results in plugging of the cell's annulus and irreversible damage to the cell.

For these reasons, there is a need for a technically and economically viable solution that minimizes scale build-up on the electrolytic cell while reducing logistical maintenance related downtime.

### SUMMARY OF THE INVENTION

The embodiments of the present invention relate to a controllable process for self-cleaning a seawater electrolytic cell or “electrolytic cell”. The process is dependent on regional seawater conductivity which varies with temperature and salinity. The process involves an automated regulation or modulation of reverse-biased power supplied to the electrolytic cell.

According to an embodiment, a process for self-cleaning an electrolytic cell is disclosed. The electrolytic cell includes a cathode and an anode electrode. The electrodes are substantially fully coated with a coating composition. A seawater stream is introduced between the electrodes. A forward bias is applied between the anode and the cathode as the stream of seawater flows between the electrodes. The forward bias is applied at a relatively high first current density. The self-cleaning process further involves applying a reverse bias to the cathode at a variable potential (as opposed to a fixed potential) to achieve a reduced, second current density. In one embodiment, the second current density is no less than 5% of a predetermined forward bias current. The reverse bias is applied at a periodic, predetermined frequency. For instance, the reverse bias is provided for a predetermined time period within each/every 24-hour period. The current can be alternated at an internal power supply. When the reverse bias is applied, the polarity of the cathode is reversed for a short duration such that it functions as an anode. This facilitates the generation of a small amount of hydrochloric acid (HCl) at the previous cathode surface. This brief “in-situ” generation of HCl at a low current density and predetermined regular frequency causes the dissolution of calcium, magnesium or any other scale deposited on the surface of the electrodes. It can also prevent further scale build-up and permanent damage to the electrodes and the coating composition on the electrodes. This ensures an optimum forward bias operation which involves the generation of a large amount of HCl.

According to another embodiment, a tubular reverse polarity (“TRP”) or reverse bias electrolytic cell, comprises: an electrically conductive external tubular sleeve formed of: (A) a tubular terminal anode; (B) a tubular terminal cathode; and a bipolar tubular electrode having a cathode end and an anode end. The terminal electrodes (the anode/cathode(s)) have a diameter that is slightly larger than the bipolar tubular electrode. This allows each terminal electrode to be slipped over the bipolar electrode. The terminal anode and terminal cathode are separated by a central coupling mechanism. Additionally, the ends of the terminal electrodes also include a coupling mechanism. An annular space separates the terminal electrodes and the bipolar electrode. The terminal electrodes and the bipolar electrode are substantially fully coated with a coating composition configured to withstand a periodic change in the forward and reverse current bias on the electrodes. According to another embodiment, a TRP electrolytic cell system involves two or more TRP electrolytic cells; a casing for enclosing the TRP electrolytic cells; and a control panel for automatically providing a forward and a reverse bias current to the TRP electrolytic cells.

### BRIEF DESCRIPTION OF THE DRAWINGS

The invention will be described in further detail below and with reference to the attached drawings all of which describe or relate to apparatus, systems and methods of the present invention. In the figures, which are not intended to be drawn to scale, each similar component that is illustrated in various figures is represented by a like numeral. In the figures:

FIG. 1 is sectional view of a tubular reverse polarity cell according to an embodiment.

FIG. 2 is a schematic diagram of a tubular reverse polarity cell assembly according to an embodiment.

FIG. 3 illustrates disassociation of deposits on the reverse polarity cell by reverse polarity according to an embodiment.

### DETAILED DESCRIPTION OF THE INVENTION

Depending on the context, all references below to the “invention” may in some cases refer to certain specific embodiments only. In other cases, it will be recognized that references to the “invention” will refer to subject matter recited in one or more, but not necessarily all, of the claims.

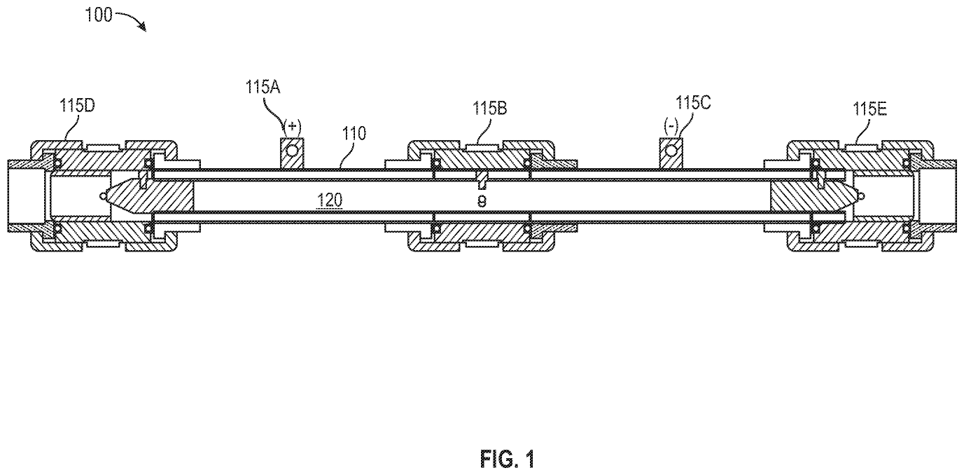

FIG. 1 is an illustration of an exemplary TRP electrolytic cell (or interchangeably “TRP cell” or just “cell”) 100. The TRP cell 100 includes an electrically conductive elongated external tubular sleeve 110. The tubular sleeve 110 comprises a tubular terminal anode electrode 115A and a terminal cathode electrode 115C (together “terminal electrodes 115”). A bipolar tubular electrode 120 is enclosed within the tubular sleeve 110. The bipolar electrode 120 has a cathode end and an opposing anode end.

The terminal electrodes 115 have a diameter that is slightly larger than the bipolar tubular electrode 120 such that an annular space is formed between an inside surface of the terminal electrodes 115 and an external surface of the bipolar electrode 120. This allows the terminal electrodes 115 to be slipped over the bipolar electrode 120. The terminal anode 115A and terminal cathode 115C are separated by a central coupling mechanism 115B. Additionally, the ends of the terminal electrodes also include a coupling mechanism 115D, 115E. The coupling mechanism can include a seal. The seal can include one or more sealing rings.

The TRP cell 100 includes an inlet and a discharge. The TRP cell 100 is configured with connection nodes to the electrodes and can facilitate the hydraulic flow of liquid throughout the cell.

The bipolar electrode 120 and the terminal electrodes 115 are substantially fully coated with a suitable composition which can withstand a reversal in the electrode polarity. In one embodiment, the coating composition/coating can include one or more metals chosen from the group of platinum group metal, e.g. ruthenium and/or iridium. In another embodiment, the coating can also include one or more metals chosen from the group of valve metals. In yet another embodiment, the coating can include at least one element selected from the group comprising nickel, iron and cobalt taken alone or in combination. However, it is understood that the coating can include other suitable and stable mixtures that can withstand periodic electrical current reversals.

The TRP cell 100 is configured to be self-cleaning. As such, the need for external acid cleaning of the TRP cell 100 is eliminated. It also eliminates any associated logistical issues and operational downtime.

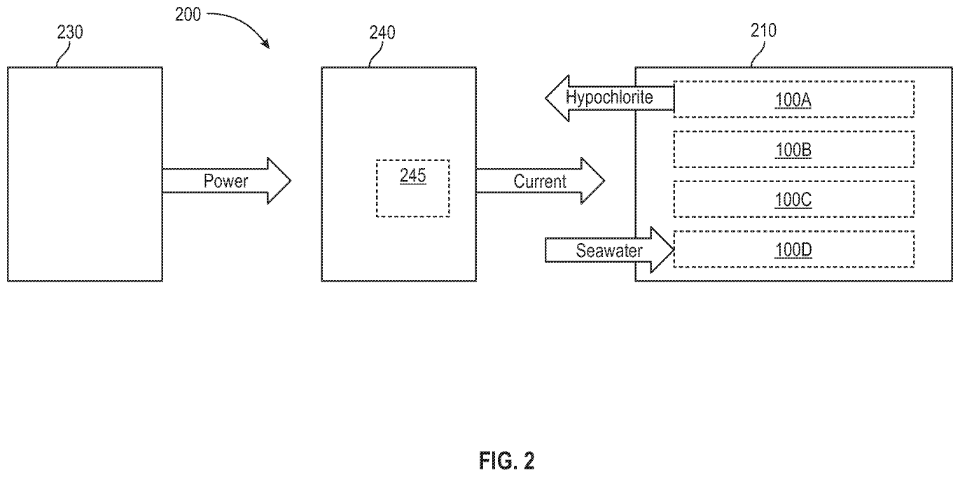

According to an embodiment, as illustrated in FIG. 2, a TRP cell system 200 includes a casing 210 enclosing a plurality of TRP cells 100A-100D (“100”) as described with reference to FIG. 1. In one embodiment, the casing 210 can be made of stainless steel. The casing 210 can be configured to enclose between 2 to 16 cells. However, a person of ordinary skill in the art can understand that the number of cells can be modified as necessary. In one or more embodiments, the cell system 200 can be skid mounted.

The cell system 200 further includes a transformer 230 which is configured to provide power to a control panel 240. The control panel 240 can include a current reversing device or mechanism 245.

During normal operation, a predetermined forward bias (DC current) is applied to the cell(s) 100. The forward bias involves the application of a high density electric current. For instance, the current density can be between 0.5-4 kA/m² as seawater flows through the cells 100. The electrolysis results in the production of a large volume of sodium hypochlorite. During this process, deposits are formed on the cell's cathode surface(s) due to the specific nature of the source feed water and the electrolysis action. The deposits can include, without limitation, calcium and magnesium deposits. A build-up of the deposits results in a deterioration in performance of the electrodes.

According to another embodiment, a process for self-cleaning the cell(s) 100 involves applying a reverse bias at a low current density, for example, at no less than 5% of the forward bias, producing a small amount of HCl which can be used to disassociate the deposits.

The reverse bias can be applied for a predetermined duration such that the deposits are dissolved without damaging the coating applied to the electrodes. In one embodiment, the reverse bias is applied at a predetermined low current density for predetermined period of time each 24-hour period. This can be followed by alternating the bias/DC current at the internal power supply at the same electrical connections to the cell. This self-cleaning process can be automated to eliminate the potential for operator error. The self-cleaning process ensures long operating life of the TRP cell and minimizes operational downtime.

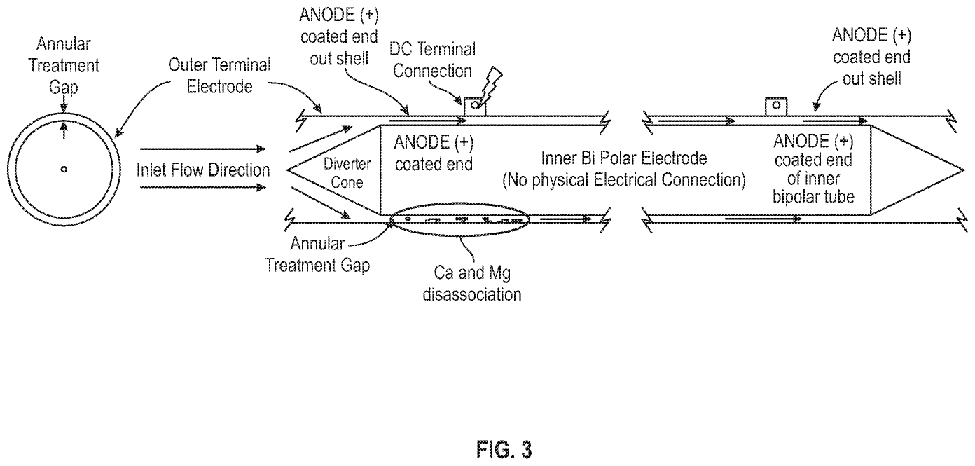

An exemplary illustration of deposit disassociation by reverse polarity, where the cathode surfaces operate as an anode, is shown in FIG. 3. When the polarity is reversed, the cathode end of the bipolar electrode and the terminal cathode both operate as anodes for a short period. The polarity can be reversed at an appropriate frequency and duration to make a small amount of HCl at the previous cathode surfaces of the electrolytic cell.

This brief “in-situ” generation of HCl, at low current density and appropriate frequency, dissolves the deposit or scale build-up on the electrodes before it gets too thick and too hard to be dissolved and prevents permanent damage to the respective electrodes to ensure optimum forward bias operation. This can facilitate continuous free-flowing operation of the electrolytic cell. Additionally, the lower current density in the reverse bias for short duration does not affect electrode life or performance while eliminating the accumulated hardness.

In one or more embodiments, the self-cleaning process described herein can be applied to any electrolyzer involving one or more electrolytic cells. For instance, the electrolyzer can include a plurality of cathode and anode electrodes.

The TRP cells can be used on large-scale or other smaller-scale installations both onshore and offshore. The embodiments of the system can also be used in water flood, cooling water and fire water loops. The TRP cells can also be used in industrial power and coastal biofouling control applications. The TRP cell has an optimal design which requires minimal operation and maintenance requirements. It has a once-through flow design which eliminates recycle requirements. The TRP cell is constructed from corrosion-resistant materials making it durable. The TRP cell assembly—including the number of TRP cells enclosed in the casing can be customized to meet site specific requirements. The TRP cells are configured to consume minimal power.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. For instance, the self-cleaning process, as disclosed herein, can be used to remove accumulated deposits from any electrolytic cell having a fully coated cathode and anode. The process does not depend on the tubular shape or size of the electrolytic cell. Additionally, the process does not depend on the presence of a bipolar electrode positioned within a sleeve containing monopolar electrodes. For example, according to an embodiment, a process for self-cleaning an electrolytic cell, comprising: (A) providing the electrolytic cell, comprising: (i) at least one cathode electrode; (ii) at least one anode electrode, wherein the electrodes are substantially fully coated with a coating; (B) applying a reverse bias to the cathode electrode at: (i) a predetermined frequency; and (ii) a predetermined time period within a 24-hour period. The process involves applying the reverse bias at no less than 5% of a predetermined forward bias. The reverse bias causes the cathode electrode to operate as an anode for a short duration. The process facilitates the generation of hydrochloric acid (HCl) to dissolve scale build-up on the electrodes.

All ranges recited herein include the endpoints, including those that recite a range “between” two values. Terms such as “about,” “generally,” “substantially,” and the like are to be construed as modifying a term or value such that it is not an absolute. Such terms will be defined by the circumstances and the terms that they modify as those terms are understood by those of skill in the art. The term “substantially” and its variations are defined as being largely but not necessarily wholly what is specified as understood by one of ordinary skill in the art.

Furthermore, no limitations are intended to the details of construction or design herein shown. It is, therefore, evident that the particular illustrative embodiments disclosed above may be altered or modified and all such variations are considered within the scope and spirit of the present invention. While system and methods are described in terms of “comprising,” “containing,” or “including” various components or steps, the system and methods also can “consist essentially of” or “consist of” the various components and steps.

1. A process for self-cleaning an electrolytic cell, comprising:
(i) introducing a stream of seawater into the electrolytic cell, wherein the electrolytic cell is configured for offshore, nearshore and coastal installations, and wherein the electrolytic cell includes:
(i) at least one cathode electrode;
(ii) at least one anode electrode,
wherein the cathode electrode is substantially fully coated with a coating composition, and wherein the anode electrodes are is also substantially fully coated with the coating composition;
(ii) applying a forward bias between the anode and the cathode electrodes at a first current density as seawater flows between the electrodes, and
(iii) providing a reverse bias at the cathode electrode, wherein the reverse bias is provided at a second current density that is lower than the first current density, and wherein the reverse bias is provided at a periodic predetermined frequency.

2. The process according to claim 1, wherein the first current density is between 0.5-4 kA/m².

3. The process according to claim 1, wherein the second current density is not less than approximately 5% of the first current density.

4. The process according to claim 2, wherein the reverse bias is provided at a variable potential to achieve a substantially reduced second current density.

5. The process according to claim 4, wherein the reverse bias facilitates generation of a small amount of hydrochloric acid in comparison to an amount of hydrochloric acid generated in the forward bias.

6. The process according to claim 5, wherein the hydrochloric acid generated during the reverse bias causes dissolution of calcium and/or magnesium deposits accumulated on the electrodes without damaging the coating composition on the electrodes.

7. The process according to claim 6, wherein the predetermined frequency is configured to prevent long-term accumulation of the deposits.

8. The process according to claim 7, wherein the reverse bias is provided for a predetermined time period within each 24-hour period.

9. The process according to claim 1, wherein the seawater flowing between the electrodes has a fixed salinity/conductivity.

10. The process according to claim 1, wherein the electrolytic cell is a tubular cell.

11. A tubular reverse polarity (“TRP”) electrolytic cell, comprising:
an electrically conductive external tubular sleeve formed of:
(i) a terminal cathode electrode;
(ii) a terminal anode electrode; and
an inner tubular bipolar electrode having a cathode end and an anode end,
wherein the terminal electrodes and the bipolar electrode are substantially fully coated with a coating composition configured to withstand a periodic reversal in polarity.

12. The TRP electrolytic cell according to claim 11, wherein the terminal electrodes have a diameter that is slightly larger than the bipolar electrode.

13. The TRP electrolytic cell according to claim 12, wherein an annular space separates the terminal electrodes and the bipolar electrode.

14. The TRP electrolytic cell according to claim 11, wherein the terminal anode and terminal cathode are separated by a central seal.

15. The TRP electrolytic cell according to claim 11, wherein each opposing end surface of the terminal electrodes comprise a seal.

16. A TRP electrolytic cell system, comprising:
at least two TRP electrolytic cells according to claim 11;
a casing for enclosing the TRP electrolytic cells; and
a control panel for automatically providing a forward and a reverse bias current to the TRP electrolytic cells.

17. The process according to claim 1, wherein the electrolytic cell is skid mounted.

18. The process according to claim 10, wherein the tubular cell comprises an electrically conductive external tubular sleeve formed of a terminal cathode electrode, a terminal anode electrode, and an inner tubular bipolar electrode having a cathode end and an anode end, wherein the terminal electrodes and the bipolar electrode are substantially fully coated with a coating composition configured to withstand a periodic reversal in polarity.

19. The process according to claim 18, wherein the terminal electrodes have a diameter that is slightly larger than the bipolar electrode.

20. The process according to claim 18, wherein an annular space separates the terminal electrodes and the bipolar electrode.

21. The process according to claim 18, wherein the terminal anode and terminal cathode are separated by a central seal.

22. The process according to claim 18, wherein each opposing end surface of the terminal electrodes comprise a seal.
